(19) United States
(12) Patent Application Publication
(10) Pub. No.: US 2017/0305247 A1
(43) Pub. Date: Oct. 26, 2017

(54) Sealing System for an Openable Panel Comprising a Profile Member Receiving a Seal Locked by a Sliding Key

(71) Applicant: FAIVELEY TRANSPORT TOURS, Saint-Pierre-des-Corps cedex (FR)

(72) Inventors: Olivier SALLES, Lecousse (FR); Laurent BAILLARGER, Joue-les-tours (FR)

(21) Appl. No.: 15/507,302

(22) PCT Filed: Aug. 20, 2015
(86) PCT No.: PCT/FR2015/052229

§ 371 Date: Feb. 28, 2017

(30) Foreign Application Priority Data
Aug. 28, 2014 (FR) 1458029

(51) Int. Cl. B60J 10/84; B60J 10/36

(52) U.S. Cl. CPC B60J 10/85; B60J 10/36

(57) ABSTRACT

A sealing system for an openable panel, an openable panel for a vehicle provided with such a sealing system, and a method for assembling and disassembling the seal of the sealing system.

### CROSS-REFERENCE TO RELATED APPLICATIONS

The present application is a National Stage Application of PCT International Application No. PCT/FR2015/052229 (filed on Aug. 20, 2015), under 35 U.S.C. §371, which claims priority to French Patent Application No. FR 148029 (filed on Aug. 28, 2014), which are each hereby incorporated by reference in their respective entireties.

### TECHNICAL FIELD

This invention relates to a sealing system for an openable panel, an openable panel for a vehicle provided with such a sealing system, and a method for assembling and disassembling the seal of the sealing system.

### BACKGROUND

A known type of sealing system, in particular for openable panels such as doors of railway vehicles, comprises a rigid profile member, made for example from an aluminum alloy, provided to be fastened onto the contour of the door, which has a recess that receives via an insertion according to an axis, a coupling portion of a seal forming a profile member with a constant section made from elastomer.

The coupling portion of the seal comprises two outer lateral bosses arranged on each side of the axis of insertion. When it is inserted into the recess of the rigid profile member, the coupling portion is deformed in order to be inserted beyond the anchor shapes carried out on each side of the profile member, which are facing the axis of insertion. Each lateral boss is adjusted in a corresponding hollow of the profile member in order to provide a fastening of the seal.

The contour of the openable panel can be straight, or comprise a certain curvature, with the rigid profile member as well as the seal then following this curvature. The seal can be made in particular from silicone, EPDM or polychloroprene.

However a problem that arises, in particular for vehicles receiving the public subjected to high constraints and to frequent stresses, such as railway cars, which can in addition be subjected to malicious acts of vandalism, is that a high resistance to pulling off must be provided.

This pulling off can comprise a traction according to the axis of insertion at any point of the seal, or the application of a torque for the lateral tipping on this seal. It can also comprise a traction on one end of the seal, which then undergoes a peeling that facilitates the pulling off thereof.

In order to provide a high resistance of the seal, bosses of this seal and corresponding anchor shapes of the profile member having a rather substantial height must be provided, or substantial rigidity of the elastomer material, which increases the resistance.

However the force required for the insertion of the coupling portion into the rigid profile member is then increased, which is done in particular by striking thereon with a mallet, which gives rise to problems with assembly time, as well as the tediousness of this operation with the repeated strokes that can result in health problems for the operator, such as tendinitis of the elbow or of the shoulder.

In addition disassembly in order to perform maintenance operations on the door or in order to replace the seal is also more complicated to carry out, and disassembly time is longer. On railway vehicles subjected to frequent stresses, maintenance can provide in particular to exchange the seals every ten years.

It is moreover known to use seals assembled by a longitudinal sliding in a complimentary shape of the rigid profile member. However this type of seal is difficult to set in place for profile members of substantial length and when the profile member comprises a rather pronounced curvature, for example on an openable panel having a substantial curvature.

Another known type of seal, presented in particular by document EP 2 689 949 A1, comprises a sealed inner space wherein a vacuum is applied in order to carry out the tightening thereof which facilitates insertion into the rigid profile member.

This type of setting in place requires a seal at the ends of the profile member, as well the use of equipment to create the vacuum, which renders the installation and removal operations more complex.

In order to improve the resistance of the seal, another type of known seal, presented in particular by document WO 2008/155098, comprises towards the front along the direction of insertion two symmetrical lips with respect to the axis of insertion, which are firstly inserted into a hollow of the rigid profile member.

The seal comprises towards the rear a closed loop forming a flexible tube forming the seal of the openable panel, which has beforehand received inside an expansion element constituted by a profile member comprising a tip directed towards the front.

After the lips have been placed in the hollow of the rigid profile member, an operator presses along the axis of insertion, on the locking element through the flexible tube in order to slide it between these lips by separating them, and locks the seal by substantially laterally compressing these lips.

This system has several disadvantages. First of all, a seal must be provided that has already received the expansion element inside the closed loop. Then, the setting in place of the expansion element requires the application of a substantial force, exerted in the form of a constant pressure or striking, in the direction of the hollow of the profile member: the assembly of such a profile member is not easy. And finally, after this assembly, another problem which arises is that the expansion element laterally compressing the two lips with a substantial maintaining, and furthermore no longer being directly accessible, it cannot be disassembled easily.

This type of seal is provided in particular for a refrigerator door, whereon there is generally no intervention for maintenance.

This invention in particular has for purpose to avoid these disadvantages of prior art.

### SUMMARY

This invention proposes for this purpose a sealing system for an openable panel, comprising a rigid profile member having a recess receiving via an insertion along an axis of insertion, a front coupling portion of a seal made of elastomer, with this profile member including side anchor shapes facing the coupling portion, characterized in that the coupling portion comprises an inner space receiving a material forming a locking key provided such as to be inserted longitudinally after the seal has been placed, with this key locking lateral protuberances on the anchor shapes of the profile member.

An advantage of this sealing system is that the coupling portion of the seal can be very flexible, allowing it to be set into place easily on the rigid profile member with reduced effort. The locking key which is inserted simply via a longitudinal sliding into the inner space, thus providing a firm maintaining of the coupling portion by preventing the deformation thereof, and the exiting of the lateral protuberances outside of the anchor shapes of the profile member allowing for the pulling off of the seal.

In addition for the disassembly the locking key can slide longitudinally in the reverse direction in order to be extracted, which allows for the deformation of the coupling portion, easily providing for the withdrawal of the seal during maintenance operations.

The sealing system according to the invention can in addition comprise one or several of the following characteristics, which can be combined together.

More generally, a first object of the invention is a sealing system for an openable panel comprising a rigid profile member and a seal, said profile member having a recess capable of receiving a coupling portion of said seal, said recess of said profile member including side anchor shapes facing the coupling portion,

characterized in that:
said flexible coupling portion of the seal includes side coupling shapes capable of engaging with said side anchor shapes of the profile member,
said coupling portion comprises an inner space located between said side anchor shapes, said inner space receiving a material forming a locking key provided such as to be inserted longitudinally after the seal has been placed in said recess, with this key locking of said side coupling shapes of the coupling portion of the seal on said side anchor shapes of the profile member.

Said seal can be a flexible seal, but at least its coupling portion must have a certain flexibility.

Said key can be a profile member or a fluid material, preferably a liquid or a granular solid.

In an embodiment said side coupling shapes of said seal include protuberances and notches. Said side anchor shapes of the profile member are projected into said notches of the coupling portion of the seal and are locked by said protuberances of the coupling portion of the seal, as such preventing the seal from being pulled off.

The sealing system can comprises bosses located directly on the key and/or opposite this key on the lateral sides of the coupling portion.

The sealing system according to the invention can comprise a system for the longitudinal fastening of the locking key.

In an embodiment of the sealing system according to the invention said rigid profile member is sandwiched between substantially parallel sheets, forming an outer and inner skin of said openable panel. Said sheets can be fastened directly onto the lateral faces of the rigid profile member, preferably for example by gluing. Said rigid profile member is advantageously a metal profile member (for example made from an aluminum alloy), which can be manufactured via extrusion.

Another object of the invention is a seal showing the aforementioned characteristics, able to be used in the sealing system according to the invention as described hereinabove.

Yet another object of the invention is a method of assembling a sealing system according to the invention, in any of its embodiments, characterized in that it comprises a step of axial insertion of the coupling portion of the seal into the recess of the rigid profile member, then a step of longitudinal insertion of the locking key into the inner space of said coupling portion of the seal.

Yet another object of the invention is a method for disassembling a sealing system according to the invention, in any of its embodiments, characterized in that it comprises a step of longitudinal withdrawal of the locking key outside of the inner space, in order to make it possible to remove the seal from the rigid profile member.

Yet another object of this invention is an openable panel of a vehicle, in particular a railway vehicle, comprising a sealing system according to the invention, in any of its embodiments, over all or a portion of its periphery.

A last object of this invention is a railway vehicle (in particular a car of a train, tramway, subway), a maritime vehicle or a road vehicle, that comprises at least one openable panel according to the invention.

### DRAWINGS

The invention shall be understood better and other characteristics and advantages shall appear more clearly when reading the description hereinafter provided by way of example, in reference to the annexed drawings wherein:

FIGS. 1a and 1b are respectively overall and detailed views of the front sealing system of a sliding door of a railway vehicle;

FIGS. 2a and 2b are respectively overall and detailed views of the rear sealing system of a sliding door of a railway vehicle;

FIGS. 3a through 3c are cross-section views of a sealing system according to the invention, having successively three steps of setting the seal in place;

FIGS. 4 to 14 are cross-section views of sealing systems according to the invention, according to different alternatives;

FIG. 15 is another overall view of the rear sealing system of a sliding door of a railway vehicle;

FIGS. 16 and 17 are cross-section views of a sealing system according to the invention, indicating each one of the radial and perpendicular pulling off forces, respectively; and

FIG. 18 shows a simplified diagrammatical view of a sealing system indicating the pulling off force by peeling.

### DESCRIPTION

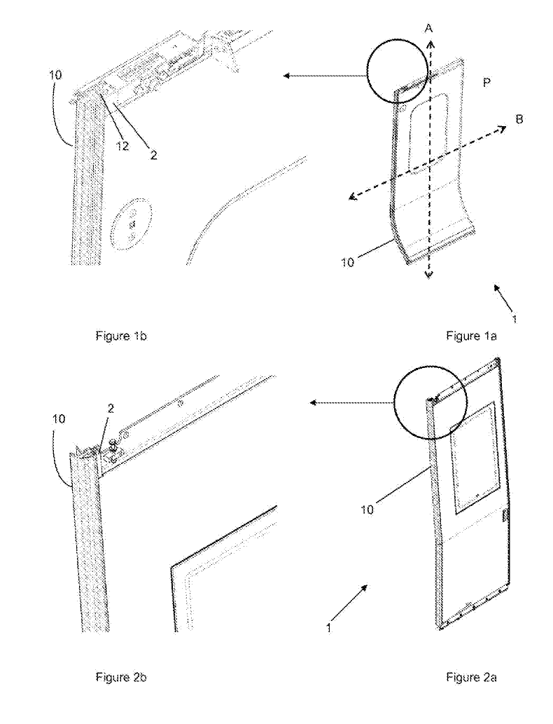

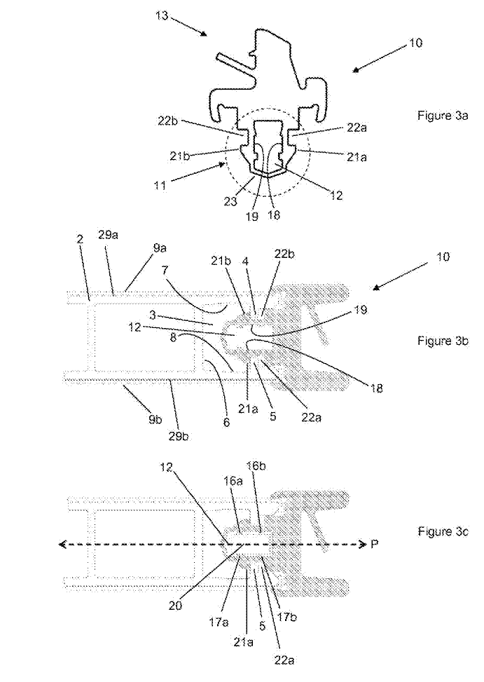

The invention relates to a sealing system for an openable panel 1, that comprises a rigid profile member 2 having a recess capable of receiving a seal 10 that is inserted according to an axis of insertion into a recess 3 of said profile member 2. Said seal can be mounted on a lateral edge of the openable panel 1, as shown in FIG. 1, and/or on another edge, for example upper or lower. The seal 10 according to the invention can be a so-called “front” seal, as shown in FIG. 1, or a so-called “rear” seal as shown in FIG. 2.

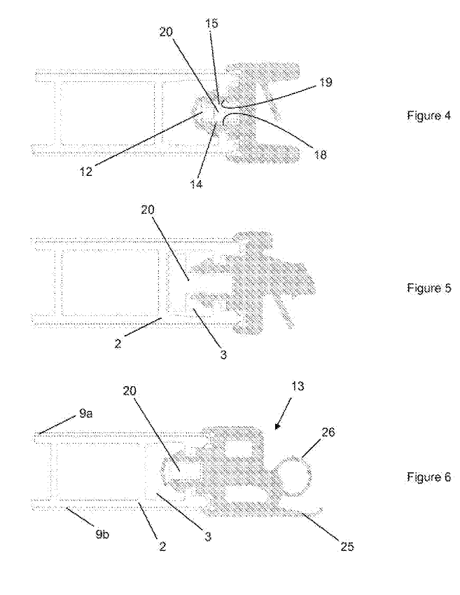

In reference to FIG. 1, an axis A is defined, called the “main” or “longitudinal” axis, an axis B, called “secondary” or “transversal” axis, and a plane P referred to as “main” wherein the axes A and B are included; this main plane is also indicated in FIG. 3c.

As shown in FIG. 3a, said seal 10 comprises a coupling portion (heel) 11 and a sealing portion 13.

As shown in FIG. 3b, said recess 3 can have the form of a groove comprising two typically parallel lateral faces 7, 8 and a groove bottom 6. On each one of said lateral faces 7, 8 is arranged a side anchor shape 4, 5 which projects inside said recess 3; in an embodiment these side anchor shapes 4, 5 are protuberances.

Said rigid profile member 2 can be made from any suitable rigid material, metal (for example aluminum) or composite. It can comprise sheets 9a, 9b forming the inner and outer walls of the openable panel 1. These sheets 9a, 9b are advantageously substantially parallel. Sais sheets 9a, 9b can be fastened onto the rigid profile member 2 by any suitable technique, for example by welding or screwing, or by gluing. In an advantageous embodiment the sheets 9a, 9b are in planes parallel to those of the lateral faces 29a, 29b of the profile member 2; said sheets 9a, 9b can be glued directly onto said lateral faces 29a, 29b of the rigid profile member 2.

Said coupling portion (heel) 11 comprises means for fastening 21, 22 comprising protuberances or protrusions 21a, 21b and slits or notches 22a, 22b able to engage with said side anchor shapes 4, 5 and facing the latter, in order to lock the seal 10 in such a way that it resists pulling off in a direction opposite the depth of said recess 3. As such the heel 11 of the seal 10 can be nested in the recess 3 of the profile member 2; this insertion can be carried out axially by a movement of the coupling portion 11 of the seal 10 according to a transversal direction, namely according to the axis B of FIG. 1a. During this movement in the direction of the bottom of the groove the heel 11 is deformed elastically in order to allow for the passage of the protuberances 21 of the seal 10 in front of the side anchor shapes 4, 5 of the profile member 2, expands when said side anchor shapes 4, 5 of the profile member 2 are opposite the slits 22a, 22b of the seal 10, and remain locked.

Said coupling portion 11 of the seal 10 comprises an inner space (recess) 12 delimited laterally by lateral sides (flanks) 18, 19. The inner space 12 can be closed (typically by a wall 23) or open in the direction of the bottom 6 of the groove 3. As shown in FIG. 3c, the inner space 12 can receive a material forming a locking key 20. This key 20 locks the means for fastening 21, 22 of the seal 10 on the anchor shapes 4, 5 of the profile member 2. More precisely, this key prevents the flanks (lateral sides) 18, 19 of the heel 11 from giving in (i.e. from being deformed elastically inwards of the inner space 12 in order to allow the protuberances 21a, 21b of the seal 10 to pass in front of the protuberances 4, 5 of the profile member 2) during the application of a pulling off force in the direction opposite the depth of the groove 6.

In a particularly advantageous embodiment, and as is shown in FIGS. 3 to 14, the heel 11 has a symmetrical structure in relation to the main plane P. As such, the protuberances 21a, 21b are on either side of this plane. Likewise, the slits 22a, 22b are located on either side of this plane. The groove of the rigid profile member 2 with its side anchor shapes 4, 5 also has a symmetry with respect to plane P. On the other hand, the sealing portion 13 of the seal 10 does not need to have a symmetrical structure in relation to plane P.

The inventors have found that the elastic deformation of the coupling portion 11 of the seal 10 when it is inserted in the direction of the bottom of the groove 6 is easier if the inner space 12 is located between the side coupling shapes 21, 22, and in particular between the slits 22a, 22b, of the seal 10, and this embodiment, shown in FIGS. 3 to 12, is preferred. In the most preferred embodiments, shown in FIGS. 3 to 11, the key 20 is also located between the side coupling shapes 21, 22, and in particular between the slits 22a, 22b, of the seal 10 as this reinforces the resistance of the seal against the pulling off.

According to a particular embodiment of the coupling portion (heel) 11, the lateral side (flank) 18, 19 of the heel 11 can comprise bosses 16, 17. These bosses 16, 17 can come into contact with the key 20 and stabilize the inner space 12 of the coupling portion 11 against the deformation, and in particular against the deformation of the flank 18, 19, during the pulling off of the seal 10, as described hereinabove. These bosses 16, 17 can have different shapes such as studs (arranged in different ways) or one or several continuous lines (more preferably parallel to the longitudinal direction of the profile member).

Advantageously on at least one lateral side 18, 19 (and preferentially on each side) said bosses 16a, 16b, 17a, 17b are located on either side of the position that takes in the sealing system according to the invention the form of fastening 4, 5 of the profile member 2 in relation to the protuberance 21, 21b, in such a way as to stabilize the engagement between the side anchor shapes 4, 5 of the profile member 2 and the means of fastening 21, 22 of the coupling portion 11 of the seal 10. Alternatively (not shown in the Figures) the bosses can be located on the key 20.

The bosses 16, 17 can facilitate the introduction of the key 20 into the recess 12 of the seal 10 because they decrease the friction surface between the lateral surfaces 14, 15 of the key 20 and the inside lateral surfaces 18, 19 of the recess 12.

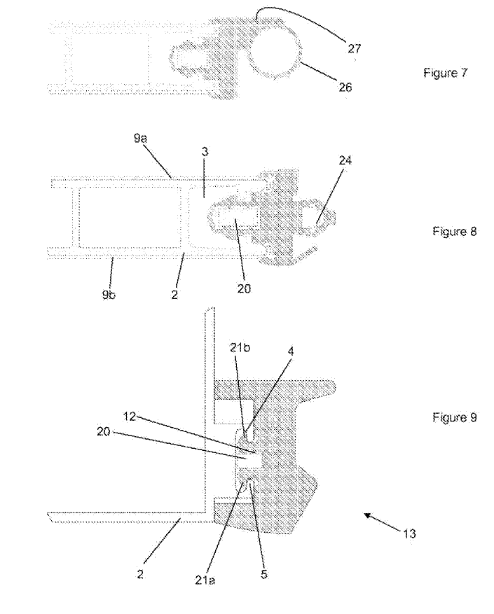

As shown in FIGS. 3 to 17 the key 20 can have different sections. It is normally a profile member with a constant section in its length. It can have a solid section. It can comprise a longitudinal hollow (as in FIGS. 11, 12, 16 and 17), and/or ribs (as in FIGS. 11 and 17). It can be an “H”-shaped profile member, as in FIG. 4, or of any other suitable section, for example circular (as shown in FIG. 12), triangular, polygonal, irregular. Advantageously the key 20 has two substantially parallel faces 14, 15 (as in FIGS. 4, 5, 10, 11, 13, 16 and 17) and which are positioned in the sealing system assembled parallel to the lateral sides 18, 19 of the coupling portion 11 of the seal 10.

However, said lateral sides 18, 19 of the coupling portion 11 of the seal 10 do not need to be parallel or flat, but can have another shape, for example curved. Likewise, and as mentioned hereinabove, the lateral sides 14, 15 of the key 20 do not need to be parallel or flat, but advantageously have a shape that engages with the shape of said lateral sides 18, 19 of the coupling portion 11 of the seal 10. By way of example, and as shown in FIG. 12, they key 20 can have a circular section, and the recess 12 can have a spherical section which allows for the inserting of said key 20.

Said seal 10 is typically made of elastomer. The surface of the inner space 12 of the coupling portion 11 of the seal 10 (and of said bosses 16a, 16b, 17a, 17b are present: preferably at least the latter) and/or the outer surface of the key 20 (and if bosses are present on the key 20: preferably at least the latter) can be partially or entirely covered by a sliding surface covering in order to reduce friction during the inserting of the key 20 into the inner space 12 of the coupling portion 11 of the seal 10 and as such facilitate the assembly and disassembly of the seal 10. This surface covering can be chosen in particular from PTFE (or Teflon®), talc, grease, soaps.

The sealing system according to the invention can comprise seals 10 that have a sealing portion 13 of a different type and shape, as shown in FIGS. 6 to 9: tubular seals with lip (FIG. 6), tubular seals without lips (FIG. 7), seals with sensitive electrical strip (FIG. 8), seals without lips (FIG. 9). More particularly:

Tubular seals with lips (FIG. 6) include in their sealing portion 13 at least one compressible tubular sealing zone 26 that provides the seal and lip 25 that reinforces the seal and hiding the tubular zone 26.

Tubular seals without lips (FIG. 7) do not comprise lips, as the tubular portion 26 which is not visible has a smooth outer surface 27.

Seals with sensitive electrical strip (FIG. 8) include a tubular zone wherein a sensitive strip 24 is located.

Seals without lips (FIG. 9) show a sealing portion 13 with low deformability, with the lip and/or tubular portion located on the seal facing (not shown in the Figure).

Generally the sealing system according to the invention requires an engagement between the profile member 2 and the seal 10 (and in particular of the coupling portion 11 of the seal 10). The shape of the profile member 2 and of said coupling portion 11 can be different, with the only condition being that this shape has a local narrowing of the lateral faces 7, 8 inside the profile member 2 (said narrowing able to form side anchor shapes 4, 5) which makes it possible to engage with the means of fastening 21, 22 of the coupling portion 11 of the seal 10.

FIGS. 10 to 14 show different geometrical shapes of the sealing system according to the invention; the narrowing is indicated by two arrows.

According to an embodiment shown in FIGS. 4, 5, 7, 8, 10, 11 and 14 of the sealing system according to the invention, the inner space 12 of the heel 11 of the seal 10 is located between the side anchor shapes 5 of the profile member 2, said anchor shapes 5 forming a narrowing; this allows for a crushing of the lateral sides 18, 19 of the heel 11 which facilitates the placing thereof in the groove of the profile member by axial insertion of the coupling portion 11 of the seal 10 in the groove according to the transversal direction, namely according to the axis B defined hereinabove. Preferably, the key is inserted into said recess between the side anchor shapes 5 of the rigid profile member 2, according to the longitudinal direction, namely according to the axis A defined hereinabove. In this embodiment, advantageously the centre of the section of the key 20 is located close to the local narrowing represented by the side anchor shapes 4, 5 of the profile member 2 (or approximately at the same level as the latter).

According to another embodiment shown in FIGS. 12 and 13 the centre is located more deeply in the recess 3 of the profile member 2, and as in said FIGS. 12 and 13 the entire key 20 can be located beyond said narrowing (seen from the outside of the profile member 2), inside the recess 3 of the profile member 2.

In an embodiment, the key 20 is bearing on the lateral faces 18, 19 of the heel 11.

In another embodiment, the key 20 does not press on the lateral faces 18, 19 of the heel 11 against the side anchor shapes 4, 5, but only prevents during the pulling off of the elastic seal 10 said lateral faces 18, 19 from being able to be compressed inwards of the inner space 12. Otherwise, it is not necessary that the outer surfaces 14, 15 of the key 20 come to bear against the lateral sides 18, 19 of the heel 11 and exert (directly or by interposed bosses 16, 17) a pressure against the lateral sides 18, 19 of the heel 11. There can even be a small clearance between the key 20 and its bearing faces on the heel 11 inside the recess 12; this will facilitate the inserting of the key 20 into said recess 12.

An advantage of the sealing system according to the invention is that the coupling portion 11 of the seal 10 can be very flexible (in particular when the shape of the coupling portion (heel) 11 is such that in the sealing system, the inner space 12 of the heel 11 is located between the side anchor shapes of the profile member), as such allowing for the setting in place of it easily on the rigid profile member 2 with reduced effort. This setting in place of the heel 11 of the seal 10 in the recess 3 of the profile member 2 can be done perpendicularly or longitudinally in relation to the recess 3 of the profile member 2, knowing that the inserting perpendicularly to the recess of the profile member (i.e. via axial insertion of the heel 11 of the seal 10 into the groove according to a transversal direction) is much easier than the longitudinal insertion thereof, especially if the sealing system according to the invention is designed in such a way that the inner space 12 of the heel 11 is located between the side anchor shapes 4, 5 forming a narrowing. The locking key 20 which is inserted simply via longitudinal sliding into the inner space 12 of the heel 11 of the seal 10 then provides a firm maintaining of the coupling portion (heel) 11 by opposing a resistance to the deformation thereof, as explained hereinabove.

In addition for the disassembly the locking key 20 can slide longitudinally in the reverse direction in order to be extracted, which allows for the deformation of the coupling portion 11, easily providing the withdrawal of the seal 10 during maintenance and replacement operations of the seal 10. The removal of the seal 10 can as such be non-destructive.

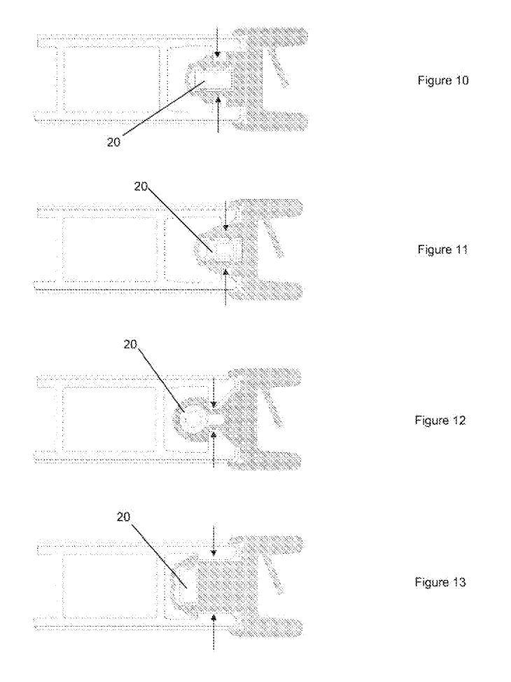

As shown in FIG. 15, the disassembly of the sealing system can be carried out in a radial pulling off manner, but as the sealing system according to the invention was designed to improve the resistance of the seal 10 to the pulling off, this operation will require the use of special tools or require the destructive opening of the seal 10 with a sharp tool that makes it possible to remove the key 20 via a radial movement (if its thickness makes it possible to pass through the local narrowing). Preferably, the disassembly is carried out by longitudinal withdrawal of the key 20 (i.e. in the axis of the seal 10), possibly after removal of the means for fastening, followed by the withdrawal of the seal 10.

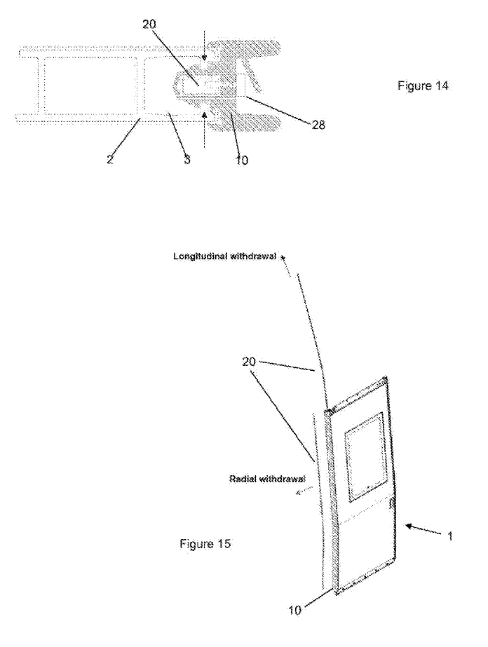

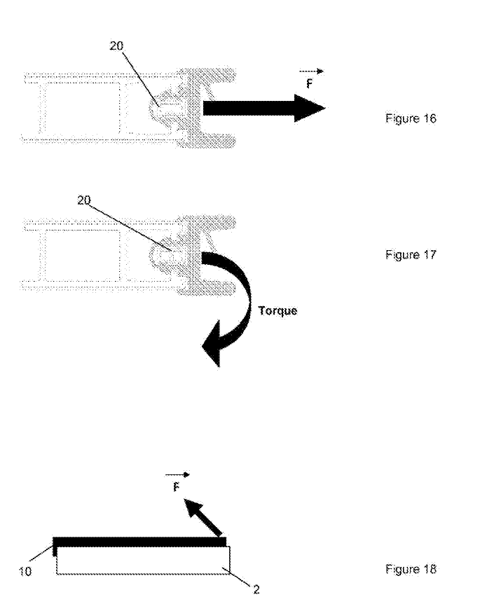

Another advantage of the sealing system according to the invention is that it has a strong resistance to the pulling off of the seal 10, while still using a seal that is easy to mount in the profile member. In particular it has a strong resistance to axial pulling off according to a transversal direction according to the axis B (FIG. 16) (with the pulling off force coming from the direction opposite the bottom of the groove), to pulling off via rotation (FIG. 17) and to pulling off by peeling (FIG. 18). The action of axial pulling off defined in FIG. 16 is carried out according to a direction opposite the action of axial insertion of the coupling portion 11 of the seal 10 in the groove according to the transversal direction defined hereinabove, materialized by the axis B; this insertion is carried out towards the bottom 6 of the groove, while the pulling off is done in the opposite direction, namely opposite the bottom of this groove.

The key 20 must be fixed in such a way that it does not exit from the seal 10 once the sealing system according to the invention is mounted on the openable panel 1: a lateral exceeding even low of the key 20 is able to hinder the operation of the openable panel 1. A means of fastening is therefore advantageously provided that prevents the key 20 from sliding longitudinally outside of the seal 10. A means for fastening the key 20 must therefore be provided in the inner space 12 of the seal 10.

Several means of fastening can be used alone or in combination. More preferably these means of fastening are reversible means, i.e. able to be disassembled without the risk of damaging the key or the seal. By way of example, a plug can be fixed at each end of the seal, as such obstructing the recess 12 of the heel 11. The key 20 can also itself be glued against the inner wall of the recess of the heel, for example using a thick flexible adhesive of the polyurethane type. An axis can also be set up in the horizontal plane, stopping the translation or translations of the key according to the vertical axis: this axis can in particular be a pin or a screw. A screw 28 can also be set in place linking the seal 10 to the key 20; this screw 28 can be self-tapping in the material of the key 20. Such an embodiment is shown in FIG. 14.

The key 20 can be made of different materials: elastomer, thermoplastic, thermoset, metal, or other suitable solid materials. The material of the key 20 can be harder than that of the seal 10, or of a comparable hardness, or more flexible.

In a particular embodiment, the key 20 is not formed of a solid material but of a fluid material. Said fluid material can for example be a liquid or a solid granular material: for example sand or granules of polymer.

The sealing system according to the invention can be used on all types of openable panels. In particular it can be used for interior and exterior openable panels of railway vehicles (in particular trains, tramways, subway), maritime, road.

### LIST OF REFERENCE NUMERALS

The following numerical markings are used in the drawings:

1 Openable panel

2 Profile member

3 Recess in the profile member 2

4, 5 Side anchor shape

6 Bottom of the groove of the profile member 2

7, 8 Lateral faces of the profile member 2

9a, 9b Sheets (walls of the openable panel 1)

10 Seal

11 Coupling portion (heel)

12 Inner space (recess)

13 Sealing portion of the seal 10

14, 15 Faces of the key

16, 17 Boss (coupling portion)

18, 19 Lateral side (flank) of the heel 11

20 Locking key

21 Protuberance or protrusion (seal 10)

22 Slit or notch (seal 10)

23 Wall (of the coupling portion)

24 Sensitive electrical strip

25 Lip

26 Tubular sealing zone

27 Smooth outer surface

28 Screw

29a, 29b Lateral faces of the profile member 2

1-14. (canceled)

15. A sealing system for an openable panel, the sealing system comprising:
a rigid profile member having a recess with side anchor members; and
a seal having a flexible coupling portion to be received by the recess and which is to face the side anchor members, the flexible coupling portion having:
side coupling members which are to engage the side anchor members, and
an inner space located between the side anchor members and which is to receive a locking key to be inserted longitudinally after the seal is placed in the recess, the locking key configured to lock the side coupling members on the side anchor members.

16. The sealing system of claim 15, wherein the rigid profile member is arranged between substantially parallel sheets forming an outer skin and an inner skin of the openable panel.

17. The sealing system of claim 16, wherein the sheets are to be fastened directly onto lateral faces of the rigid profile member.

18. The sealing system of claim 15, wherein the side coupling members include protuberances and notches.

19. The sealing system of claim 18, wherein the side anchor members are to project into the notches, and are locked by the protuberances so as to prevent removal of the seal.

20. The sealing system of claim 15, further comprising bosses to be arranged directly on the locking key and/or opposite the locking key on lateral sides of the coupling portion.

21. The sealing system of claim 15, further comprising a fastener system to longitudinally fasten the locking key.

22. The sealing system of claim 15, wherein the locking key comprises a profile member.

23. The sealing system of claim 15, wherein the locking key is to be arranged between the side coupling members.

24. The sealing system of claim 15, wherein the locking key comprises a fluidic material.

25. The sealing system of claim 15, wherein the locking key comprises a liquid.

26. The sealing system of claim 15, wherein the locking key comprises a granular solid.

27. A method for sealing an openable panel, the method comprising:
axially inserting a flexible coupling portion of a seal in a recess of a rigid profile member; and
longitudinally inserting a locking key of the flexible coupling portion into an inner space of the flexible coupling portion to seal the openable panel.

28. The method of claim 27, further comprising withdrawing the locking key from the inner space to remove the seal.

29. An openable panel of a vehicle, comprising:
a sealing system that includes a rigid profile member having a recess with side anchor members, and a seal having a flexible coupling portion to be received by the recess and which is to face the side anchor members, the flexible coupling portion having:
side coupling members which are to engage the side anchor members, and
an inner space located between the side anchor members and which is to receive a locking key to be inserted longitudinally after the seal is placed in the recess, the locking key configured to lock the side coupling members on the side anchor members
in particular a railway vehicle, comprising a sealing system, wherein this sealing system is carried out according to any of claims 1 to 11 over all or a portion of its periphery.

30. The openable panel of claim 29, wherein the openable panel is for a railway vehicle, and the sealing system is to be applied to at least a portion of the periphery of the openable panel.
